(19) United States
(12) Patent Application Publication
(10) Pub. No.: US 2025/0045701 A1
(43) Pub. Date: Feb. 6, 2025

(54) COMPATIBILITY EVALUATION APPARATUS, COMPATIBILITY EVALUATION METHOD, AND PROGRAM

(71) Applicant: NIPPON TELEGRAPH AND TELEPHONE CORPORATION, Tokyo (JP)

(72) Inventors: Takashi FURUTANI, Tokyo (JP); Masaki HISADA, Tokyo (JP); Minako HARA, Tokyo (JP)

(21) Appl. No.: 18/713,479

(22) PCT Filed: Dec. 13, 2021
(86) PCT No.: PCT/JP2021/045881

§ 371 Date: May 24, 2024

(51) Int. Cl. G06Q 10/1053

(52) U.S. Cl. CPC G06Q 10/1053

(57) ABSTRACT

A compatibility evaluation apparatus that evaluates compatibility between a target person and an evaluation target includes: an input unit configured to input target person text information that is text information on the target person; an evaluation unit configured to calculate a target person feature amount that is a non-financial feature amount from the target person text information, and calculate an evaluation target feature amount that is a non-financial feature amount from evaluation target text information that is text information on the evaluation target; and a compatibility calculation unit configured to calculate the compatibility based on the target person feature amount and the evaluation target feature amount.

### TECHNICAL FIELD

The present invention relates to a technique for evaluating compatibility between a target person (such as a job-hunting student) and an evaluation target (such as a company) by using non-financial information on the evaluation target (such as a company).

### BACKGROUND ART

Non-financial information on a company, which is represented by environment, society, and governance (ESG), is being emphasized in evaluating social value of the company.

Until now, economic value of a company, that is, financial information (profit amount, profit rate, and the like) has been a main evaluation material in determining a company value in investment or the like. However, in recent years, not only financial information but also non-financial information such as efforts for ESG and SDGs is an important material for evaluating social value of a company and selecting an investment destination. Meanwhile, as for a role of a company itself, company activities that emphasize social value rather than economic value, such as company activities of Grameen Bank, have also appeared.

Meanwhile, in recent years, due to the influence of coronavirus and the like, what job-hunting students and workers changing jobs require from companies is also changing. There is a tendency to give importance to non-financial information such as working in a challenging or interesting field rather than economic aspects such as an annual income and a compensation package, which have been given importance so far. This tendency is confirmed by an actual questionnaire and the like.

However, methods for evaluation of a company and evaluation of compatibility with a company using these pieces of non-financial information are not fixed, and there is a problem that a job-hunting student cannot efficiently select a company.

### CITATION LIST

### Non Patent Literature

Non Patent Literature 1: Heisei 30-nendo kankyo sustainable kigyo hyoka kento-kai (dai 1-kai) (in Japanese) (Environmentally Sustainable Companies Evaluation Meeting in 2018 (first meeting), Mitsubishi UFJ Research and Consulting Co., Ltd., p4, http://www.env.go.jp/policy/j-hiroba/kigyo/R1/ESGkakudukeGirei.pdf, searched on Dec. 3, 2021

### SUMMARY OF INVENTION

### Technical Problem

In a case where social value of a company is evaluated, an index of an ESG investment brand (referred to as an ESG index) is generally used at present, but the ESG index is evaluated based on public information (updated once a year or the like) on the company, and details of evaluation criteria and processes are not disclosed.

In addition, the public information on the company is assumed to be prepared with external consultation in many cases, and is assumed to be information based on subjective evaluation. Therefore, it is unclear whether ESG efforts in the public information on the company (for example, efforts regarding the SDGs) and the like reflect the actual state of the company activities. The public information on the company and evaluation by a rating company are also subjective and black boxes. In addition, in the conventional evaluation method, it is conceivable that there is bias by the company, and thus there is a possibility that the evaluation does not reflect the actual state of the company activities.

From the above point of view, public information such as the ESG index is insufficient for a job-hunting student to select a company with which he/she is compatible as a place of employment. Therefore, it is necessary to investigate each piece of company information, which requires a large amount of labor. A method for automatically evaluating compatibility between a job-hunting student and a company is desired.

The present invention has been made in view of the above points, and an object thereof is to provide a technique that makes it possible to automatically evaluate compatibility between a target person (for example, a job-hunting student) and an evaluation target (for example, a company).

### Solution to Problem

According to the disclosed technique, there is provided a compatibility evaluation apparatus that evaluates compatibility between a target person and an evaluation target,
the compatibility evaluation apparatus including:
an input unit configured to input target person text information that is text information on the target person;
an evaluation unit configured to calculate a target person feature amount that is a non-financial feature amount from the target person text information, and calculate an evaluation target feature amount that is a non-financial feature amount from evaluation target text information that is text information on the evaluation target; and
a compatibility calculation unit configured to calculate the compatibility based on the target person feature amount and the evaluation target feature amount.

### Advantageous Effects of Invention

According to the disclosed technique, there is provided a technique that makes it possible to automatically evaluate compatibility between a target person (for example, a job-hunting student) and an evaluation target (for example, a company).

### BRIEF DESCRIPTION OF DRAWINGS

FIG. 1 is a diagram for describing an existing evaluation method.

FIG. 2 is a diagram for describing an outline of an embodiment.

FIG. 3 is a configuration diagram of a compatibility evaluation apparatus.

FIG. 4 is a diagram illustrating a hardware configuration example.

FIG. 5 is a diagram illustrating an image of feature amount calculation.

FIG. 6 is a flowchart of processing.

FIG. 7 is a diagram for describing an output example.

FIG. 8 is a diagram for describing an output example.

FIG. 9 is a diagram for describing an output example.

FIG. 10 is a diagram for describing an output example.

### DESCRIPTION OF EMBODIMENTS

Hereinafter, an embodiment of the present invention (present embodiment) will be described with reference to the drawings. The embodiment described below is merely an example, and an embodiment to which the present invention is applied is not limited to the following embodiment.

For example, in the following embodiment, a company is assumed as an evaluation target of compatibility with a job-hunting student, but the technique according to the present invention can also be applied to a case other than the case where the evaluation target is a company. In addition, a subject whose compatibility with an evaluation target is evaluated (such a subject is referred to as a target person) is not limited to a job-hunting student.

For example, with the technique according to the present invention, it is also possible to evaluate compatibility between a certain target person and an individual, a group, a country, a local government, or the like. Furthermore, although processing is performed on Japanese text in the following embodiment, this is an example, and the technique according to the present invention can be applied to any language.

### Problem and Outline of Embodiment

As described above, in the conventional technique, the ESG index is often used in a case where social value of a company is evaluated. However, it is uncertain whether the ESG index reflects the actual state of company activities that change from moment to moment. First, this point will be described using an example of a conventional ESG rating method.

For example, as disclosed in “MSCI (2017) MSCI ESG Research ESG Rating Methodology Summary”, in the conventional ESG rating, first, key issues are selected and weighted in each industry, and risk exposure and risk management for each key issue are scored for each company. A key issue score is obtained from these two scores.

In order to perform relative evaluation of companies in the industry, the weighted average score of each company is standardized to determine an Industry Adjusted Score, and an ESG score is determined based on the Industry Adjusted Score.

In the determination of the ESG score as described above, public information on a company is used as an information source, and an annual report such as a sustainability report is used as the public information.

However, from the public information on the company that is issued only once a year, it is not possible to sufficiently evaluate non-financial factors that change from moment to moment, such as SDGs efforts. In addition, there are many cases where external consultation or the like is involved in preparation of public information on a company, and it is not clear whether the actual state is accurately reflected.

From the above point of view, public information such as the ESG index is insufficient for a job-hunting student to select a company with which he/she is compatible as a place of employment. Therefore, it is necessary to investigate each piece of company information, which requires a large amount of labor. A method for automatically evaluating compatibility between a job-hunting student and a company is desired.

In order to solve the above problem, in the present embodiment, it is possible to automatically evaluate non-financial compatibility with a company from text information such as a reason for an application of a job-hunting student.

That is, a compatibility evaluation apparatus 100 according to the present embodiment solves the above-described problem, and a job-hunting student can efficiently evaluate non-financial compatibility with a company without investigating each piece of company information. In the present embodiment, compatibility in terms of social value is calculated as the non-financial compatibility.

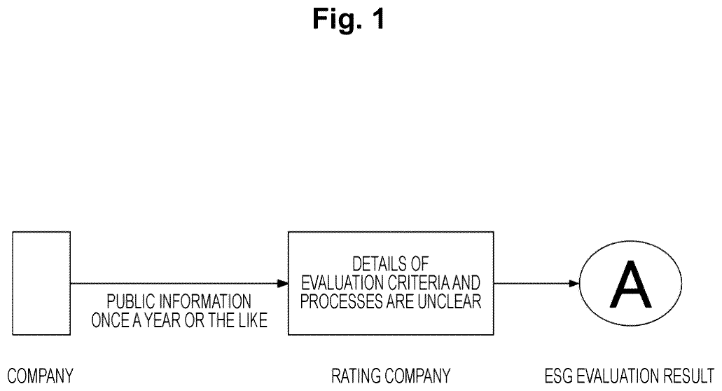

For comparison with the method for evaluating non-financial compatibility according to the present embodiment, a method for evaluating non-financial compatibility based on evaluation of a company according to the conventional technique will be described with reference to FIG. 1. As illustrated in FIG. 1, in the conventional technique, a rating company uses, for example, the public information published once a year to perform evaluation in an unclear process and publish the evaluation result. The evaluation result is, for example, rating information “A”. A job-hunting student cannot grasp the actual situation of the company even when looking at such information. Therefore, in order to determine compatibility with a company, it is necessary to collect more information regarding the company, which requires a large amount of labor.

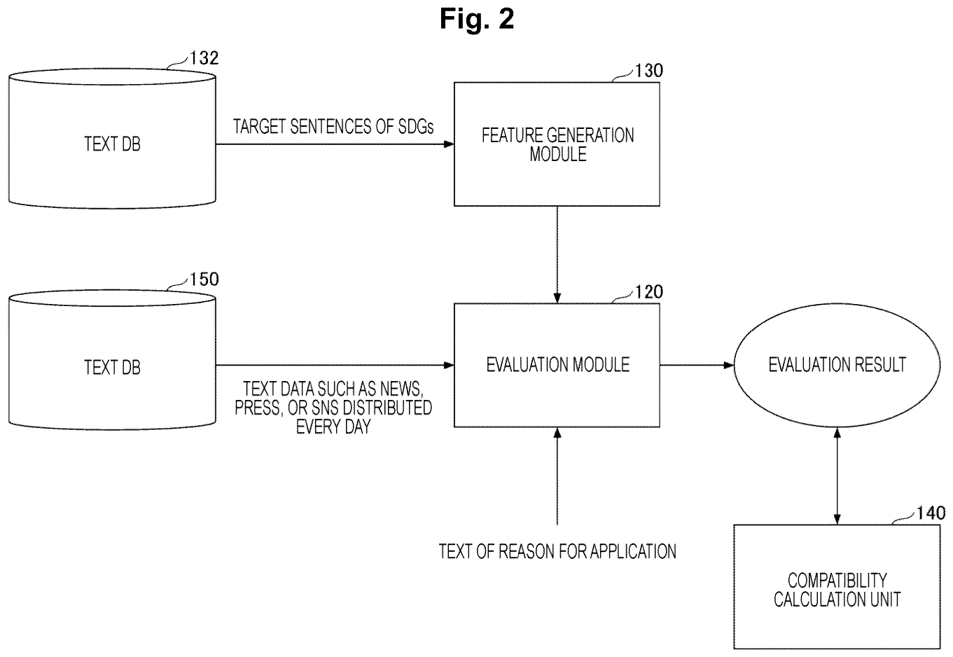

FIG. 2 is a diagram illustrating an operation outline of the compatibility evaluation apparatus 100 according to the present embodiment. As illustrated in FIG. 2, a feature generation module 130 calculates a feature amount related to social value from text information related to evaluation of the social value (for example, target sentences of the SDGs), which is read from a text DB 132, and stores the feature amount. Note that the feature generation module 130 may be referred to as a feature generation unit.

Subsequently, an evaluation module 120 inputs text information including a plurality of sentences such as news, press, or SNS acquired from a text DB 150, evaluates relevance between the text information and the feature amount generated by the feature generation module 130, and outputs a feature amount of a company (evaluation target feature amount) based on the evaluation result. In addition, the evaluation module 120 inputs text information (the reason for the application or the like) described by a job-hunting student, evaluates relevance between the text information and the feature amount generated by the feature generation module 130, and outputs a feature amount of the job-hunting student (target person feature amount) based on the evaluation result.

A compatibility calculation unit 140 then calculates relevance (similarity or the like) between the evaluation target feature amount and the target person feature amount to calculate compatibility between the company and the job-hunting student. The compatibility is calculated, for example, as a similarity.

Hereinafter, examples of the configuration and operation of the compatibility evaluation apparatus 100 will be described in more detail as a practical example.

### (Configuration Example of Compatibility Evaluation Apparatus 100)

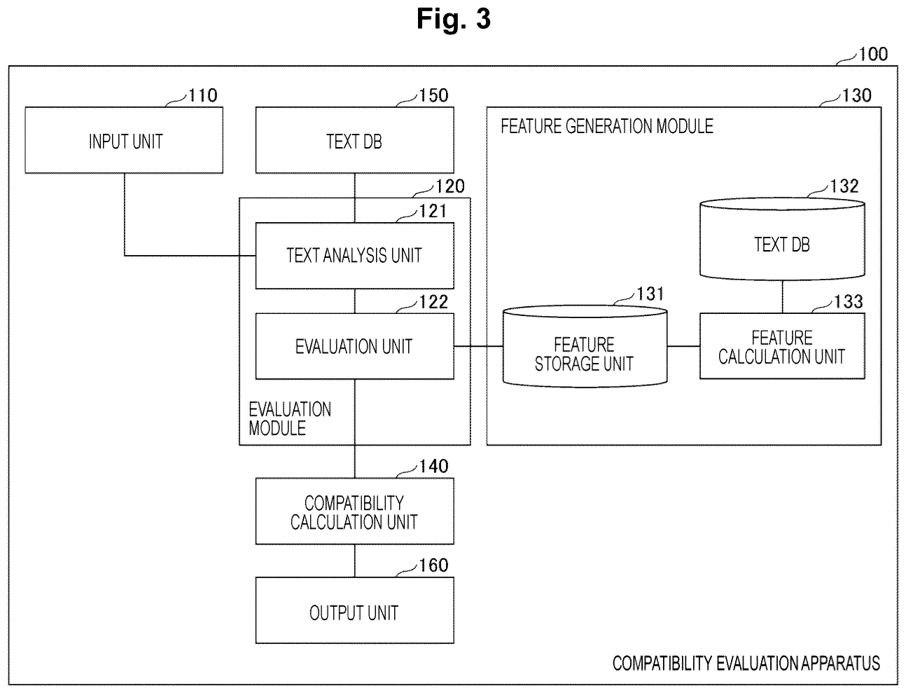

First, a configuration example of the compatibility evaluation apparatus 100 will be described. FIG. 3 illustrates a detailed configuration example of the compatibility evaluation apparatus 100. As illustrated in FIG. 3, the compatibility evaluation apparatus 100 includes an input unit 110, the evaluation module 120, the feature generation module 130, the compatibility calculation unit 140, the text DB 150, and an output unit 160.

The evaluation module 120 includes a text analysis unit 121 and an evaluation unit 122. In addition, the feature generation module 130 includes a feature storage unit 131, the text DB 132, and a feature calculation unit 133.

Operation outlines of the evaluation module 120, the feature generation module 130, and the compatibility calculation unit 140 are as described with reference to FIG. 2. Detailed operation of each of the units constituting the compatibility evaluation apparatus 100 will be described in an operation example to be described later.

### <Hardware Configuration Example>

The compatibility evaluation apparatus 100 can be implemented, for example, by causing a computer to execute a program. This computer may be a physical computer or a virtual machine on a cloud.

That is, the compatibility evaluation apparatus 100 can be implemented by a program corresponding to processing performed by the compatibility evaluation apparatus 100 being executed by use of hardware resources such as a CPU and a memory built in a computer. The program can be stored and distributed by being recorded in a computer-readable recording medium (portable memory or the like). The program can also be provided through a network such as the Internet or an electronic mail.

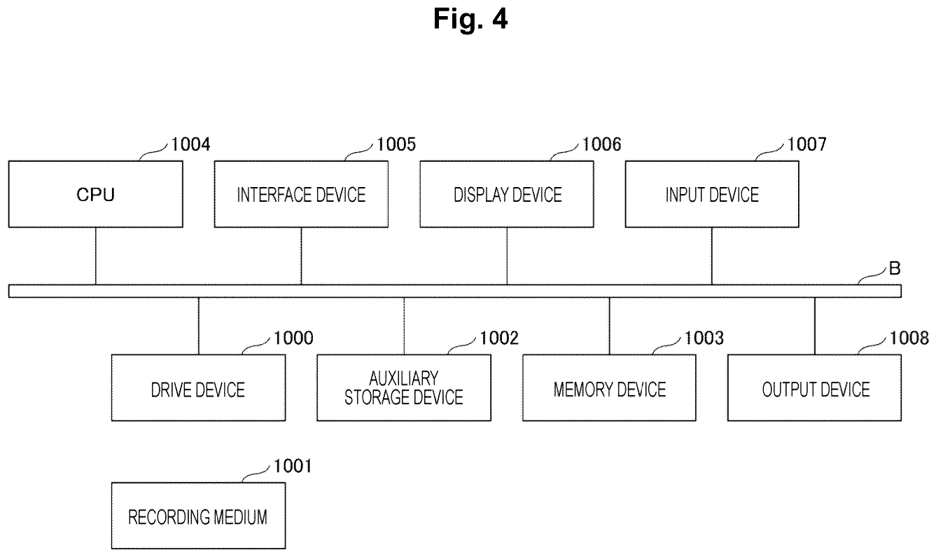

FIG. 4 is a diagram illustrating a hardware configuration example of the computer. The computer in FIG. 4 includes a drive device 1000, an auxiliary storage device 1002, a memory device 1003, a CPU 1004, an interface device 1005, a display device 1006, an input device 1007, an output device 1008, and the like, which are connected to each other by a bus BS.

The program for implementing the processing in the computer is provided, for example, through a recording medium 1001 such as a CD-ROM or a memory card. When the recording medium 1001 storing the program is set in the drive device 1000, the program is installed from the recording medium 1001 to the auxiliary storage device 1002 via the drive device 1000. However, the program is not necessarily installed from the recording medium 1001 and may be downloaded from another computer via a network. The auxiliary storage device 1002 stores the installed program and also stores necessary files, data, and the like.

When an instruction to start the program is given, the memory device 1003 reads the program from the auxiliary storage device 1002 and stores the program. The CPU 1004 implements a function related to the compatibility evaluation apparatus 100 according to the program stored in the memory device 1003. The interface device 1005 is used as an interface for connecting to a network, and functions as a transmission unit and a reception unit. The display device 1006 displays a graphical user interface (GUI) or the like according to the program. The input device 1007 includes a keyboard and a mouse, buttons, a touch panel, or the like, and is used to input various operation instructions. The output device 1008 outputs a computation result.

### (Operation Example of Compatibility Evaluation Apparatus 100)

Next, an operation example of the compatibility evaluation apparatus 100 will be described. The compatibility evaluation apparatus 100 can evaluate compatibility between a job-hunting student and various companies, but, hereinafter, an example of evaluating compatibility between a certain company (referred to as “compatibility evaluation target company”) and a certain job-hunting student will be described.

In the present embodiment, first, feature amounts are generated from text information related to non-financial features and stored. This stage is referred to as a feature amount generation phase. Next, evaluation of compatibility between the job-hunting student and the compatibility evaluation target company is executed by use of the stored feature amounts. This stage is referred to as an evaluation phase. Each of the feature amount generation phase and the evaluation phase will be described below.

### (Feature Amount Generation Phase)

The text DB 132 of the feature generation module 130 stores, for example, a plurality of sentences (text information) indicating goals of activities for increasing social value. Specifically, for example, 169 target sentences of the SDGs are stored. The targets or goals may be referred to as social value indexes.

Note that, in the feature generation module 130, using the target sentences of the SDGs as information used to extract the non-financial features is an example. This is an example of focusing on social value of the company, and this makes it possible to evaluate compatibility between the company and the job-hunting student in terms of the social value. In a case of extracting non-financial features from other viewpoints, sentences other than the target sentences of the SDGs are used.

The feature calculation unit 133 inputs the plurality of sentences read from the text DB 132 and performs morphological analysis on each sentence. The morphological analysis makes it possible to obtain keywords or the like from the input sentences. For the morphological analysis, any technique may be used. For example, natural language processing techniques such as a Tf-idf method, a co-occurrence analysis, and a dependency analysis, a text mining technique, and the like can be used. In addition, a morphological analysis tool such as Mecab, JUMAN, or ChaSen may be used.

Note that, instead of extracting keywords from the text information as described above, any keywords may be subjectively (manually) set.

In the present practical example, the feature calculation unit 133 generates 109 feature amounts from the 169 target sentences of the SDGs. The feature calculation unit 133 generates a feature amount including a vector from one or a plurality of keywords, using a pre-learned word embedding vector such as word2Vec, GloVe, fastText, or the like. At this time, averaging, normalization, or the like may be appropriately performed between the plurality of keywords.

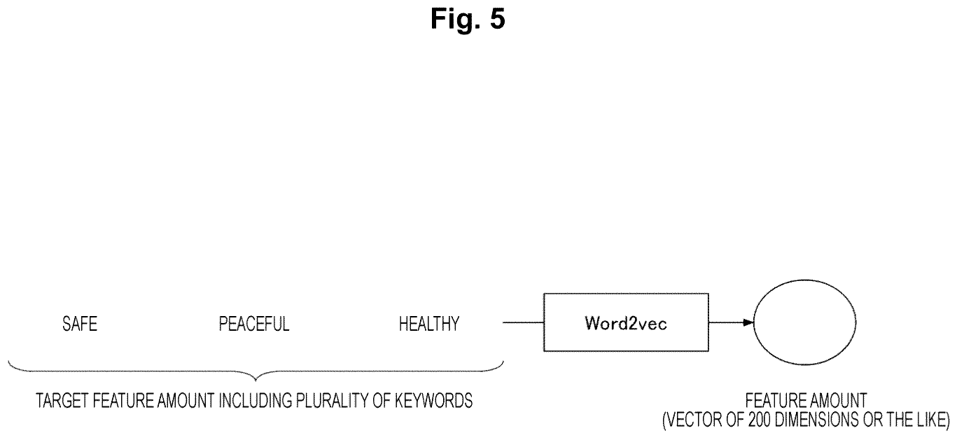

FIG. 5 illustrates an image in a case where the vector of the feature amount is generated by use of word2Vec. In the example illustrated in FIG. 5, a feature amount (vector of 200 dimensions or the like) is obtained from one target including three keywords of “safe”, “peaceful”, and “healthy” by use of word2Vec.

The feature amount obtained by the feature calculation unit 133 is stored in the feature storage unit 131. For example, the feature storage unit 131 stores a feature amount (vector) for each of 109 targets. The feature storage unit 131 may store, together with the feature amount, the target sentence or the plurality of keywords based on which the feature amount is calculated.

### (Evaluation Phase)

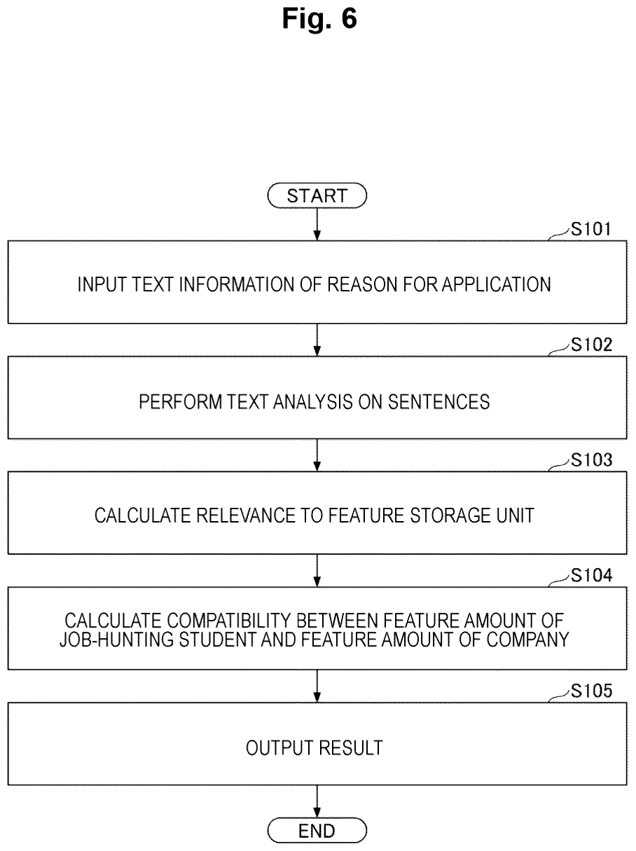

Next, an operation example of the compatibility evaluation apparatus 100 in the evaluation phase will be described along the procedure illustrated in the flowchart of FIG. 6. Note that the order of the processing illustrated in FIG. 6 is an example, and the processing may be performed in any order as long as an evaluation result can be calculated. In addition, a plurality of pieces of processing may be executed in parallel.

As a premise of the flowchart of FIG. 6, it is assumed that the text information regarding the compatibility evaluation target company is stored in the text DB 150. The text information is information obtained in real time regarding the compatibility evaluation target company, and the text DB 150 is updated as needed by the real-time text information.

The text information may be any text information regarding the compatibility evaluation target company, such as press, news release, or SNS. In the present practical example, it is assumed that a news release of the evaluation target company, which is provided from a PR company, is input to the text DB 150. Note that the text DB 150 may be provided outside the compatibility evaluation apparatus 100.

### <S101>

In S101 (step 101), the text information such as the reason for the application described by the job-hunting student is input to the input unit 110. For example, the input unit 110 displays a web screen on a terminal of the job-hunting student, and the job-hunting student inputs the text information on the web screen. The input text information is passed to the text analysis unit 121 of the evaluation module 120.

Furthermore, in S101, the text information (news release or the like) regarding the compatibility evaluation target company is input from the text DB 150 to the evaluation module 120.

Note that examples of the sentence of the reason for the application input by the job-hunting student include the following sentences.

“ . . . I was interested in your company because I knew that your company, which offers web services for small and medium sized companies, enables individuals or small teams to engage in sales. I would like to work in an environment where I could see the value of what I can offer, taking advantage of my knowledge of IT infrastructure, and I applied for your company.”

### <S102>

In S102, the text analysis unit 121 of the evaluation module 120 performs text analysis on the text information (which may be referred to as “sentences” or “document”) input in S101.

Here, the text analysis is performed for each of the text information such as the reason for the application by the job-hunting student (referred to as “job-hunting student text information”) and the text information on the compatibility evaluation target company such as a news release (referred to as “company text information”).

Specifically, for example, similarly to the method described in the “feature amount generation phase”, the text analysis unit 121 performs morphological analysis on the input text, and generates a feature amount using a word embedding vector or the like for one or more keywords obtained by the morphological analysis.

For convenience of description, a feature amount obtained from the job-hunting student text information is referred to as a job-hunting student feature amount, and a feature amount obtained from the company text information is referred to as a company feature amount.

### <S103>

In S103, the evaluation unit 122 calculates relevance (specifically, similarity) between the feature amounts obtained by the text analysis unit 121 and each feature amount (each target) read from the feature storage unit 131. Here, the evaluation unit 122 calculates similarity between the job-hunting student feature amount and each feature amount read from the feature storage unit 131, and similarity between the company feature amount and each feature amount read from the feature storage unit 131.

For example, assuming that 109 feature amounts (vectors) corresponding to 109 targets are stored in the feature storage unit 131, the evaluation unit 122 calculates similarity between each of the 109 feature amounts and the feature amounts obtained by the text analysis unit 121.

In the similarity calculation, any method may be used as long as similarity between two pieces of information can be calculated. For example, cosine similarity can be used. In a case where the cosine similarity is used, similarity between a feature amount x and a feature amount y can be calculated by the following equation.

$$cos ( x , y ) = x \cdot y / \vert x \vert \times \vert y \vert$$

For example, the evaluation unit 122 can extract any number of keywords each having a particularly high similarity from the input text (news release in the case of the company text information) for each feature amount (that is, for each target) stored in the feature storage unit 131, and can set an average of the similarities of the any number of keywords, a numerical value obtained by performing normalization processing, or the like as a similarity of the calculation result.

For example, the evaluation unit 122 may extract 10 keywords each having a high similarity. For example, it is assumed that the similarity calculation obtains a keyword 1, a keyword 2, . . . , and a keyword 10 as top 10 keywords each having a high similarity to a certain target A.

In this case, it is assumed that respective feature amounts of the 10 keywords are a feature amount 1, a feature amount 2, . . . , a feature amount 9, and a feature amount 10, and a feature amount corresponding to the target A stored in the feature storage unit 131 is a feature amount A. The evaluation unit 122 calculates a similarity 1 between the feature amount 1 and the feature amount A, a similarity 2 between the feature amount 2 and the feature amount A, . . . , a similarity 9 between the feature amount 9 and the feature amount A, and a similarity 10 between the feature amount 10 and the feature amount A.

For example, the evaluation unit 122 can calculate an average value, a minimum value, and a maximum value of the 10 similarities 1 to 10 to the target A, and output the average value, the minimum value, and the maximum value as a calculation result of similarity to the target A. Note that such a calculation method is an example.

The above similarity calculation is performed for each of the job-hunting student text information and the company text information.

### <S104>

In S104, the compatibility calculation unit 140 calculates the compatibility between the job-hunting student and the compatibility evaluation target company based on the calculation result obtained by the evaluation unit 122. The compatibility calculation method is not limited to a specific method, and for example, the following method is used.

For example, it is assumed that a target having the highest similarity to the job-hunting student text information is the target A, and a target having the highest similarity to the company text information is a target B.

In this case, for example, the compatibility calculation unit 140 extracts a keyword having a high similarity to the feature amount of the target A (for example, top N similarities (N is an integer of 1 or more)) from the job-hunting student text information, calculates a feature amount of the extracted keyword (referred to as a target person feature amount), extracts a keyword having a high similarity to the feature amount of the target B (for example, top N similarities) from the company text information, and calculates the feature amount of the extracted keyword (referred to as an evaluation target feature amount). Note that these feature amounts may be calculated by the evaluation module 120.

The compatibility calculation unit 140 then calculates, for example, cosine similarity between the target person feature amount and the evaluation target feature amount, thereby calculating similarity that serves as compatibility between the job-hunting student and the compatibility evaluation target company. If the cosine similarity is high, it can be determined that the compatibility is good.

Furthermore, as described above, in addition to calculating the compatibility with the feature amounts of the keywords extracted from the job-hunting student text information and the company text information, the compatibility may be calculated with the feature amounts of the keywords extracted from the target sentences.

An example of this case will be described. For example, it is assumed that a target having the highest similarity to the job-hunting student text information is the target A, and a target having the highest similarity to the company text information is the target B. In this case, the compatibility calculation unit 140 calculates a feature amount of a keyword extracted from the target sentence of the target A (referred to as target person feature amount), and calculates a feature amount of a keyword extracted from the target sentence of the target B (referred to as evaluation target feature amount). The compatibility calculation unit 140 then calculates, for example, cosine similarity between the target person feature amount and the evaluation target feature amount, thereby calculating the compatibility between the job-hunting student and the compatibility evaluation target company. If the cosine similarity is high, it can be determined that the compatibility is good.

Furthermore, for example, it is assumed that, in a case where a target having the highest similarity to the job-hunting student text information is the target A, and a target having the highest similarity to the company text information is also the target A, keywords for the target A are “Support for establishment and growth of small and medium companies”. In this case, the feature amount of the company (feature amount of “Support for establishment and growth of small and medium companies”) is the same as the feature amount of the job-hunting student (feature amount of “Support for establishment and growth of small and medium companies”), a high similarity is obtained, and it can be determined that the compatibility between the company and the job-hunting student is good.

### <S105>

The output unit 160 outputs the evaluation result. The output of the evaluation result may be, for example, graphical display on a screen of a user interface (UI) of a display of the compatibility evaluation apparatus 100, or may be output of a list of numerical values. In addition, the output of the evaluation result may be displayed as a web screen on the terminal of the user (the job-hunting student).

As information to be output, not only the result of the compatibility calculation (the similarity described above) but also the similarity between the job-hunting student text information and each target and the similarity between the company text information and each target may be output.

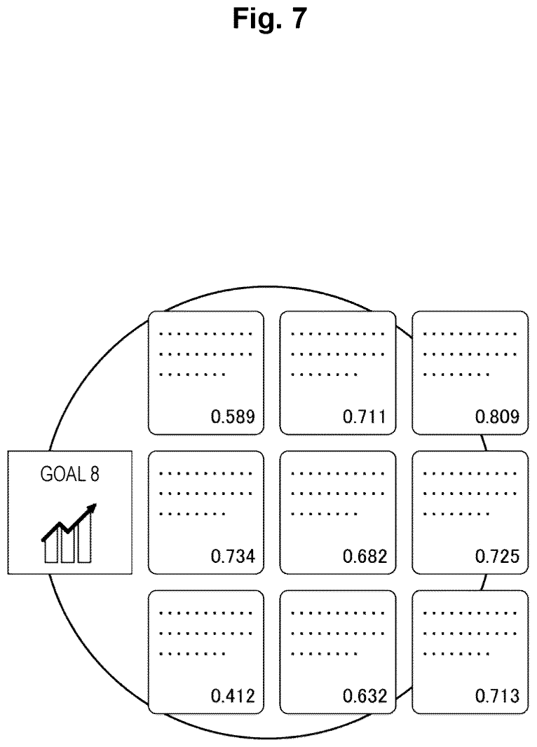

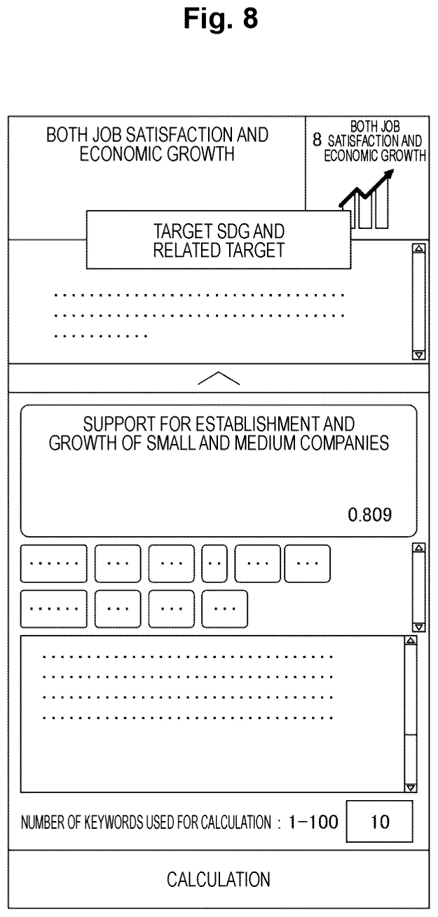

With reference to FIGS. 7 and 8, a display example in a case where the similarity between the job-hunting student text information and each target is output will be described.

FIG. 7 illustrates an example in which nine target sentences are displayed for a certain goal (for example, goal 8). As illustrated in FIG. 7, a similarity such as 0.589 is displayed for each target. An image as illustrated in FIG. 7 may be displayed for each of all the goals.

Furthermore, for example, the screen illustrated in FIG. 8 can also be displayed when the user selects (clicks) a certain target on the screen. FIG. 8 is a screen illustrating information on the selected target in detail. In addition, the number of keywords used for calculation can also be designated on this screen. As described above, in the above example, the number of keywords=10 is set.

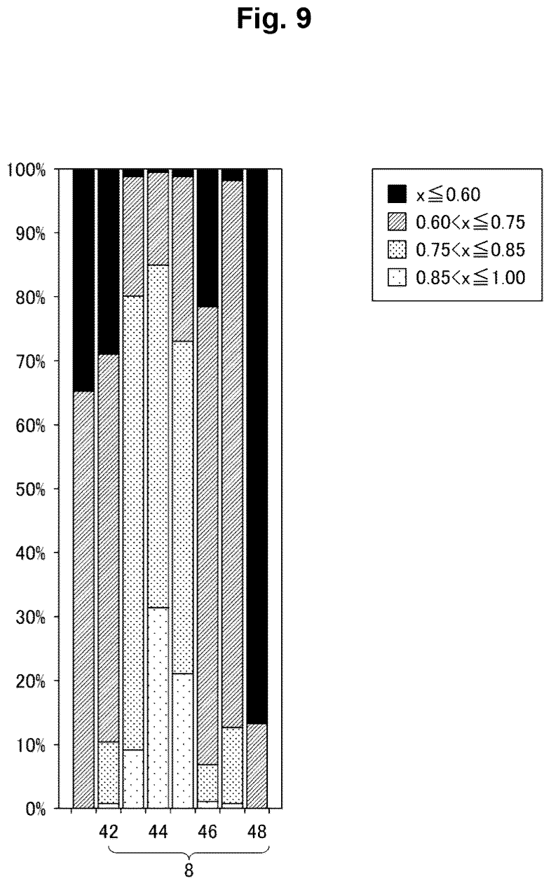

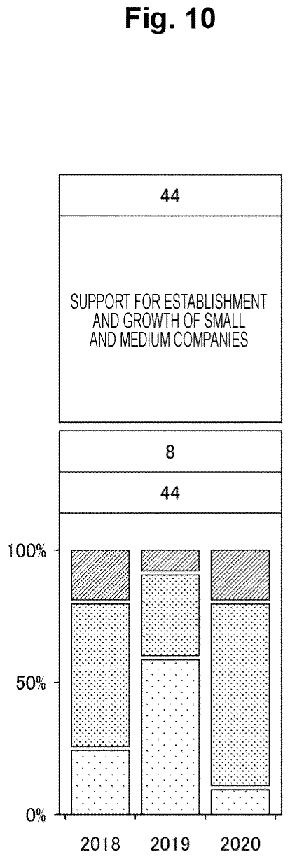

Furthermore, regarding the similarity between the company text information and each target, screens as illustrated in FIGS. 9 and 10 can be displayed. For convenience of illustration, a part of the display screens is illustrated. In this example, 109 targets are put together into 17 goals of the SDGs, a similarity for each target for each goal (a plurality of similarities corresponding to a plurality of keywords) is calculated, and ratios are displayed.

In the example of FIG. 9, the ratio of each range of the value of similarity is displayed for each target number indicated on the horizontal axis. In FIG. 9, the ranges of the ratios are distinguished by hatching, but may be distinguished by a difference in color. Furthermore, in the example of FIG. 9, the number of the goal corresponding to the plurality of target numbers is indicated on the horizontal axis. In the example of FIG. 10, an annual change in the evaluation result is illustrated. In connection with FIGS. 9 and 10, information regarding the evaluation target company text information may be displayed. The information is, for example, a target company name, a period and the number of news releases, and the like.

For example, the user (the job-hunting student) can comprehensively determine the compatibility from the information indicating the relevance between the job-hunting student text information and the targets illustrated in FIGS. 7 and 8 and the information indicating the relevance between the company text information and the targets illustrated in FIGS. 9 and 10.

For example, if the similarity between the job-hunting student text information and the target A is high, and the similarity between the company text information and the target A is also high, the user can determine that the compatibility with the compatibility evaluation target company is good in terms of social value for the target A. Furthermore, if the similarity between the job-hunting student text information and the target B is high and the similarity between the company text information and the target B is low, the user can determine that the compatibility with the compatibility evaluation target company is not good in terms of social value for the target B.

### Effects of Embodiment

As described above, the compatibility evaluation apparatus 100 according to the present embodiment can objectively evaluate non-financial efforts of a company for various evaluation axes (for example, each target) from text information distributed every day, such as press, news release, or SNS, regardless of public information such as an annual report of the company. In addition, since the evaluation is performed by input of the text data of the company, it is possible to perform objective evaluation in real time reflecting the actual activities of the company.

Since the compatibility evaluation apparatus 100 calculates the compatibility from the non-financial features of the company and features acquired from the text information on the reason for the application of the job-hunting student, it is possible to automatically calculate the compatibility based on objective evaluation.

In addition, if there is a text such as the reason for the application of the job-hunting student, it is possible to automatically perform compatibility evaluation for a large number of companies.

### (Supplement)

The present specification discloses at least a compatibility evaluation apparatus, a compatibility evaluation method, and a program according to the following clauses.

### (Clause 1)

A compatibility evaluation apparatus that evaluates compatibility between a target person and an evaluation target,
the compatibility evaluation apparatus including:
an input unit configured to input target person text information that is text information on the target person;
an evaluation unit configured to calculate a target person feature amount that is a non-financial feature amount from the target person text information, and calculate an evaluation target feature amount that is a non-financial feature amount from evaluation target text information that is text information on the evaluation target; and
a compatibility calculation unit configured to calculate the compatibility based on the target person feature amount and the evaluation target feature amount.

### (Clause 2)

The compatibility evaluation apparatus according to clause 1, further including
a feature generation unit configured to generate a feature amount as a social value feature amount from text information related to evaluation of social value, wherein
the evaluation unit calculates the target person feature amount based on relevance between the target person text information and the social value feature amount, and calculates the evaluation target feature amount based on relevance between the evaluation target text information and the social value feature amount.

### (Clause 3)

The compatibility evaluation apparatus according to clause 1 or 2, wherein
the target person is a job-hunting student, the evaluation target is a company, and the target person text information is text information describing a reason for an application of the target person to enter a company.

### (Clause 4)

A compatibility evaluation method executed by a compatibility evaluation apparatus that evaluates compatibility between a target person and an evaluation target,
the compatibility evaluation method including:
an input step of inputting target person text information that is text information on the target person;
an evaluation step of calculating a target person feature amount that is a non-financial feature amount from the target person text information, and calculating an evaluation target feature amount that is a non-financial feature amount from evaluation target text information that is text information on the evaluation target; and
a compatibility calculation step of calculating the compatibility based on the target person feature amount and the evaluation target feature amount.

### (Clause 5)

A program for causing a computer to function as each unit in the compatibility evaluation apparatus according to any one of clauses 1 to 3.

Although the present embodiment has been described above, the present invention is not limited to such a specific embodiment, and various modifications and changes can be made within the scope of the gist of the present invention described in the claims.

### REFERENCE SIGNS LIST

100 Compatibility evaluation apparatus
110 Input unit
120 Evaluation module
121 Text analysis unit
122 Evaluation unit
130 Feature generation module
131 Feature storage unit
132 Text DB
133 Feature calculation unit
140 Compatibility calculation unit
150 Text DB
160 Output unit
1000 Drive device
1001 Recording medium
1002 Auxiliary storage device
1003 Memory device
1004 CPU
1005 Interface device
1006 Display device
1007 Input device
1008 Output device

1. A compatibility evaluation apparatus that evaluates compatibility between a target person and an evaluation target, the compatibility evaluation apparatus comprising:
a processor; and
a memory storing program instructions that cause the processor to:
input target person text information that is text information on the target person;
calculate a target person feature amount that is a non-financial feature amount from the target person text information, and calculate an evaluation target feature amount that is a non-financial feature amount from evaluation target text information that is text information on the evaluation target; and
calculate the compatibility based on the target person feature amount and the evaluation target feature amount.

2. The compatibility evaluation apparatus according to claim 1, wherein the program instructions further cause the processor to:
generate a feature amount as a social value feature amount from text information related to evaluation of social value, and
calculate the target person feature amount based on relevance between the target person text information and the social value feature amount, and calculates the evaluation target feature amount based on relevance between the evaluation target text information and the social value feature amount.

3. The compatibility evaluation apparatus according to claim 1, wherein
the target person is a job-hunting student, the evaluation target is a company, and the target person text information is text information describing a reason for an application of the target person to enter a company.

4. A compatibility evaluation method executed by a compatibility evaluation apparatus that evaluates compatibility between a target person and an evaluation target, the compatibility evaluation method comprising:
inputting target person text information that is text information on the target person;
calculating a target person feature amount that is a non-financial feature amount from the target person text information, and calculating an evaluation target feature amount that is a non-financial feature amount from evaluation target text information that is text information on the evaluation target; and
calculating the compatibility based on the target person feature amount and the evaluation target feature amount.

5. A non-transitory computer-readable recording medium having stored therein a program for causing a computer to perform a process comprising:
inputting target person text information that is text information on the target person;
calculating a target person feature amount that is a non-financial feature amount from the target person text information, and calculating an evaluation target feature amount that is a non-financial feature amount from evaluation target text information that is text information on the evaluation target; and
calculating the compatibility based on the target person feature amount and the evaluation target feature amount.
